(19) United States
(12) Patent Application Publication
(10) Pub. No.: US 2018/0319505 A1
(43) Pub. Date: Nov. 8, 2018

(54) PNEUMATIC CUSHION HAVING PUMP UNIT

(71) Applicant: LANTAL TEXTILES AG, Langenthal (CH)

(72) Inventors: Roland VON BALLMOOS, Erlenbach (CH); Andreas GUEHMANN, Madetswil (CH); Harald RINER, Beinwil am See (CH)

(73) Assignee: LANTAL TEXTILES AG, Langenthal (CH)

(21) Appl. No.: 15/771,649

(22) PCT Filed: Oct. 5, 2016
(86) PCT No.: PCT/EP2016/073789

§ 371 Date: Apr. 27, 2018

(30) Foreign Application Priority Data
Nov. 18, 2015 (CH) 1683/15

(51) Int. Cl. B64D 11/06

(52) U.S. Cl. CPC B64D 11/0647; B64D 11/0639

(57) ABSTRACT

The invention relates to a pump unit for inflating and deflating a pneumatic cushion, comprising a pump with two conveying directions, a first fluid line to connect the pump to the pneumatic cushion, and a second fluid line with which the pump can be connected to a supply line or the atmosphere, as well as a first pressure sensor that is connected to the first fluid line or to the second fluid line in order to measure a fluid pressure present in the fluid line. The pump unit also has a control unit that is connected to the pump and to the first pressure sensor. The pump, at least one part of the first fluid line, the second fluid line, the first pressure sensor and the control unit are arranged in a common housing.

### TECHNICAL FIELD

The invention relates to a pneumatic cushion having a pump unit, wherein the components of the pump unit are arranged in a housing.

### PRIOR ART

In order to make individual adjustment of the comfort possible during sitting, the classic foam cushions in vehicle and aircraft seats are replaced by pneumatic cushions in which the seat hardness can be adapted by varying the air filling. In particular in the region of aircraft seats, weight can additionally be saved by the use of pneumatic cushions.

Individually adjustable seat cushions are used nowadays in particular in higher classes of aircraft seats, such as first class or business class. In particular in the region of lower priced classes of seat, an individually adjustable seat hardness is not necessarily desired for cost reasons; however, it is possible to save a considerable amount of weight by the use of pneumatic cushions, in particular in the case of large-capacity aircraft. Since the cabin pressure is substantially lower at cruising height than when the aircraft is standing on the ground, there is the problem, however, that pneumatic cushions having a static, that is to say invariable air filling, are harder during cruising than on the ground since the internal pressure of the pneumatic cushions is increased because of the external pressure which is significantly lower during cruising flight. Such a cushion thus feels too soft on the ground and too hard during cruising flight.

In order to obtain a consistently pleasant seat hardness, a system which is as simple and cost-effective as possible and which varies the filling of the pneumatic cushion during ascending flight and descending flight in such a manner that the cushion consistently feels pleasant for a passenger sitting thereon, would accordingly be desired.

To this end, WO 98/41126 A1 (McCord Winn Textron Inc.) proposes that a pneumatic cushion has a pressure regulator which always maintains a predetermined ratio between internal pressure of the cushion and the cabin pressure. When the predetermined pressure is exceeded, the pressure regulator causes a discharge valve to open. In order to increase the internal pressure, the pressure regulator interacts with a bellows pump which is mechanically actuated by the movements of a passenger on the seat. The pressure regulator has a controller with a microprocessor and a cabin pressure sensor.

A disadvantage of such a system is that active movements of the passenger are necessary in order to build up the necessary pressure by means of the bellows pump so as to reinflate the cushion with air during descending flight.

DE 20 02 403 U1 (ASF Thomas Industries GmbH) describes a different approach. DE 20 02 403 U1 describes a seat, in particular for vehicles, with at least one balloon, which is fillable with a medium, in the padding. By means of an integrated control, the balloon is brought to a desired state by targeted, pump-assisted insertion or emptying of medium. Use is made here of a double action pump which can be readjusted from a filling operation to an emptying operation. One pump which is connected via a line system with valves to the balloons located in the seat is provided here per seat.

A disadvantage of this system is that a complex interlinking of the balloons by fluid lines is necessary. Furthermore, a multiplicity of valves are required for controlling the inflation and emptying of the balloons, which complicates the design of the seat and leads to a higher weight.

### SUMMARY OF THE INVENTION

It is the object of the invention to provide a pneumatic cushion which belongs to the technical field mentioned at the beginning and which permits as simple a design of a seat as possible, wherein the pneumatic cushion is actively inflated or emptied depending on an external pressure, in particular the cabin pressure.

The object is achieved by the features of claim 1. The pneumatic cushion according to the invention comprises at least two surface elements which are connected to one another all around at their edges in a gas-tight manner such that a volume which is fillable with air is produced between the at least two surface elements. The pneumatic cushion furthermore has a pump unit which comprises a pump, a first fluid line which connects the pump to the volume of the pneumatic cushion, and a second fluid line with which the pump is connected to a fluid inlet opening. The pump, at least part of the first fluid line and the second fluid line are arranged in a common housing.

The arrangement of all of the components in a common housing makes it possible to produce a particularly compact pump unit which has all of the necessary elements in order to permit active adaptation of an internal pressure of a pneumatic cushion depending on the ambient pressure. The compact construction makes it possible for each pneumatic cushion on a seat to be able to be equipped with a pump unit, which renders the arrangement of fluid lines and valves in the seat superfluous. Furthermore, pneumatic cushions of this type can be mass-produced for different applications, and therefore cost-effective production is possible.

The at least two surface elements are preferably manufactured from a flexible or elastic material which is gas-tight. Particularly preferably, the at least two surface elements comprise at least one film composed of a polymer, a copolymer and/or a polymer blend.

Particularly preferably, the pneumatic cushion is cuboidal. For this purpose, the pneumatic cushion preferably has six surface elements which are connected to one another at their edges in such a manner that the pneumatic cushion obtains the shape of a cuboid. Furthermore, however, the pneumatic cushion may also have other suitable shapes, for example may be cylindrical or polygonal in any manner. As a result, the pneumatic cushion according to the invention can be used not only in the region of the seat surface or of the backrest, but also as a contour cushion which provides a passenger on the seat with lateral support, or else as a functional cushion, for example as a lordosis support. In order to obtain a gas-tight volume between the at least two surface elements, the latter have to be connected to one another by means of a gas-tight connection, such as, for example, by means of an adhesive surface.

The pneumatic cushion according to the invention is particularly preferably used in an aircraft seat. However, it is also conceivable for a pneumatic cushion of this type also to be used in a vehicle, such as, for example, a car, train or bus.

The first fluid line and/or the second fluid line are/is preferably arranged in such a manner that a first end of the fluid lines is connected to the pump and a second end of the fluid lines to mutually opposite sides of the housing of the pump unit. As a result, the pump unit can be arranged in a side surface of the pneumatic cushion, wherein a fluid can be conveyed by the fluid lines and the pump from outside the pneumatic cushion into the volume and vice versa.

The second end of the first fluid line preferably lies within the pneumatic cushion, that is to say, the first fluid line opens directly in the volume of the pneumatic cushion. Particularly preferably, the first fluid line opens into an inner opening which is arranged on a housing wall which lies within the volume.

In an alternative embodiment, only part of the first fluid line is arranged within the housing, wherein a further part extends outside the housing. The pump unit can thereby also be arranged at a distance from the volume of the pneumatic cushion formed by the at least two surface elements. For example, the pump unit can be arranged on a seat substructure to which the pneumatic cushion is attached. The connection between the pump unit and the volume is ensured by the first fluid line which is connected to an opening in one of the at least two surface elements or penetrates one of the at least two surface elements. An advantage of this embodiment is that it is possible only to exchange the pump unit in the event of a malfunction. Furthermore, the pump unit is more easily accessible, for example for maintenance or repair work.

In a preferred embodiment, the second fluid line is divided into two partial fluid lines which are releasably connectable to each other, wherein a first part of the first fluid line extends from the pump as far as a wall of the housing, and a second part of the first fluid line extends from the housing to the volume of the pneumatic cushion. The releasable connection between the parts is preferably gas-tight and releasable by hand. For example, a screw connection is suitable for this purpose.

In addition to the described arrangement of the pump unit at a distance from the volume of the pneumatic cushion, it can be provided, in a further embodiment, that the pump unit is arranged within the volume. In this case, the fluid inlet opening which is preferably arranged in a side wall of the housing is connected via a feedline to an opening which is arranged in one of the at least two surface elements.

The fluid inlet opening is preferably connected to the surrounding atmosphere, that is to say to the air present outside the housing and the pneumatic cushion. In certain embodiments, it can be provided that said connection is realized via a feed line which extends, for example, between an opening in one of the at least two surface elements and the inlet opening. When the pneumatic cushion according to the invention is used in an aircraft, the surrounding atmosphere corresponds to the cabin air. Alternatively, the fluid inlet opening may also be connected via a further feedline to a gas reservoir or similar.

Air is in particular used as the fluid. However, the use of a gas, in particular an inert gas, which can be conveyed by the pump unit from a reservoir or a gas supply into the volume of pneumatic cushion, is also conceivable.

For the power supply, the pump unit preferably has a connection plug with which the pump unit can be connected to an external power supply, for example the power supply of the backrest monitor of the on-board entertainment system or of a USB connection arranged in the seat, in an aircraft. In the case of an external power supply, the voltage and the maximum power consumption of the pump unit are preferably adapted to the respective power supply network, i.e., for example, a voltage of 28 volts upon connection to the power supply of the backrest monitor. Alternatively, however, the pump unit can also have an optionally rechargeable energy store, for example in the form of an accumulator or a battery.

The common housing preferably has a cylindrical or cuboidal shape. The pump and the fluid lines are preferably arranged in such a manner that the fluid is substantially conveyed along the longitudinal axis of the housing. Alternatively, the common housing may also have any other shape which is suitable for accommodating all of the components of the pump unit, such as, for example, any desired polygonal shape.

The housing is preferably manufactured from a plastic, such as, for example, from a thermoplastic polymer, such as ABS (acrylonitrile-butadiene-styrene copolymer). Particularly preferably, the housing of the pump unit is welded in an opening in a surface element of the pneumatic cushion such that fluid can be pumped through the surface element by the pump unit.

A diaphragm pump which in particular has one conveying direction is preferably used as the pump. The diaphragm pump preferably comprises an electric drive.

Alternatively, the pump can also be a flow pump which permits continuous conveying of the fluid. The pump can be configured, for example, as a rotary piston pump or impeller pump.

Furthermore, a pump having two conveying directions can be used as the pump. Within the context of the present application, a “pump having two conveying directions” is understood as meaning a pump which is capable of conveying fluid both from the second fluid line into the first fluid line and also vice versa from the first fluid line into the second fluid line. That is to say, the pump can both pump and also actively empty the pneumatic cushion. This makes it possible to adapt the internal pressure of the pneumatic cushion as rapidly as possible.

The pump is preferably configured in such a manner that, in the switched-off state, it separates the first and the second fluid line in a gas-tight manner. As an alternative preference, a nonreturn valve can be arranged in the first fluid line and prevents air from flowing out of the volume when the pump is switched off.

The housing preferably penetrates one of the at least two surface elements. As a result, the volume and the pump unit of the pneumatic cushion form a compact unit which can be arranged without further adaptations on new and also on already existing seats. In this embodiment, the housing is preferably arranged in such a manner that it projects as little as possible beyond the surface element. Particularly preferably, the housing is arranged in the surface element in such a manner that a wall of the housing is flush with the surface element. The fluid inlet opening and any connection plugs are preferably arranged in a wall or in part of a wall which lies on an outer side of the surface element.

The pump unit preferably has a third fluid line with which the volume of the pneumatic cushion can be connected to a fluid outlet opening.

As a result, a pump having only one direction of action can be used since emptying of the volume of the pneumatic cushion is made possible by means of the third fluid line. The third fluid line preferably has a valve with which a fluid flow through the third fluid line can be interrupted.

The third fluid line preferably has a resistance, in particular a narrowed point or a throttle valve. As a result, the flow of the fluid can be limited to a predetermined maximum flow. This limits the speed with which the pneumatic cushion is emptied, as a result of which an abrupt change in the volume of the pneumatic cushion, which is unpleasant for a passenger sitting on the pneumatic seat, does not take place.

The third fluid line is preferably connected to the first fluid line, in particular via a T piece.

In one embodiment of the present invention, use is made of a pump having one direction of action, which constantly conveys air at a first predefined pressure from the surrounding atmosphere into the first fluid line. Some of this air will escape again into the surrounding atmosphere via the third fluid line, wherein the quantity of air escaping via the third fluid line is limited to a maximum value by means of a resistance. A second part of the air conveyed by the pump will pass into the volume of the pneumatic cushion. By means of the ambient pressure and a person sitting on the pneumatic cushion, a force is exerted on the pneumatic cushion, with which air is pressed out of the volume with a second pressure into the first fluid line. By a suitable choice of the conveying power of the pump, and therefore of the first predefined pressure, and also of the resistance, a predefined internal pressure can thus be maintained within the volume of the pneumatic cushion, said internal pressure being obtained by means of an equilibrium between the quantity of air supplied by the pump and the quantity of air escaping through the third fluid line.

Preferably, the pump unit has a first pressure differential sensor with which a pressure differential between the inner space of the volume of the pneumatic cushion and the ambient pressure can be measured. Furthermore, the pump unit has a control unit, wherein the control unit is configured in such a manner that, when a pressure differential measured by the first pressure differential sensor falls short of a predetermined desired differential pressure, the pump is activated in order to inflate the pneumatic cushion until the measured pressure differential corresponds to the predetermined desired differential pressure.

The control unit preferably has a printed circuit board and a microchip with which at least the pump can be activated. Furthermore, the control unit can also have a memory module in which, for example, desired pressure values can be stored.

The pressure differential sensor preferably has at least two piezo elements, wherein one piezo element is arranged within the volume or in the first fluid line in order to measure the pressure prevailing within the volume, and wherein a second piezo element is arranged outside the pneumatic cushion in order to measure the pressure in the surrounding atmosphere.

The desired differential pressure is preferably fixedly predetermined and stored in a memory module of the control unit. Alternatively, it is also possible for the desired differential pressure to be able to be varied, for example via an input device. As a result, the pressure within the pneumatic cushion and therefore the hardness of the cushion can be adjusted individually.

The first fluid line preferably has a valve. The volume of the pneumatic cushion can be selectively separated from the pump or from the third fluid line, if the latter is connected to the first fluid line, via said valve.

The valve is preferably a 3/2-way valve, wherein the third fluid line is preferably connected to the first fluid line via the valve. In this embodiment, the control unit is configured in such a manner that, when the predetermined desired differential pressure is exceeded, the valve is switched in such a manner that the volume of the pneumatic cushion is connected to the fluid outlet opening via the third fluid line until the measured pressure differential corresponds to the desired differential pressure. Accordingly, the volume of the pneumatic cushion can be selectively connected to the pump or to the third fluid line via such a valve.

The control unit is furthermore configured in such a manner that, when the desired differential pressure is fallen short of, the valve is switched in such a manner that the volume is connected to the pump, wherein the pump is activated in order to fill the volume until the desired differential pressure is reached.

In a variant embodiment of the present invention, the third fluid line between the pump and the valve is connected to the first fluid line, in particular via a T piece.

The control unit is preferably configured in such a manner that, when the desired differential pressure is exceeded or fallen short of, the valve is opened. When the desired differential pressure is exceeded, the pump is switched off. As a result, air can escape from the volume of the pneumatic cushion via the third fluid line. When the desired differential pressure is fallen short of, the pump is additionally activated. The latter conveys air into the first fluid line, wherein some of said air escapes through the third fluid line. The escaping quantity of air is limited by the resistance which is preferably present. The conveying power of the pump is therefore preferably selected in such a manner that it is higher than the maximum flow of the air through the resistance. As a result, despite the quantity of air escaping through the third fluid line, the volume of the pneumatic cushion can be filled.

In a further embodiment of the present invention, a first pressure sensor is preferably connected to the first fluid line in order to measure the pressure prevailing in the first fluid line. The pump unit preferably has a control unit which is configured in such a manner that the pump is activated depending on the pressure, which is measured by at least one sensor, in the first fluid line in order to inflate or to empty the pneumatic cushion.

As a result, a constant internal pressure can always be maintained in the pneumatic cushion. In particular in the event of changing pressure conditions outside the pneumatic cushion, for example as a consequence of ascending flight or descending flight, the same seat hardness can always be automatically maintained for a passenger sitting on the pneumatic cushion.

The control unit preferably compares the pressure measured by the first sensor with a desired pressure which is preferably stored in a memory module in the control unit. Particularly preferably, a specific desired pressure can be set for each pump unit during production. Thus, different hardnesses can be set for pneumatic cushions in different positions on a seat. Alternatively, the control unit is configured in such a manner that the desired pressure can be changed via an interface, for example via a specific maintenance device or even via an input device on the seat, which can be operated by a passenger.

In order to prevent inflation or emptying of the pneumatic cushion in the event of minor pressure changes, it is provided in particular that a predetermined tolerance pressure range around the desired pressure is defined. If a pressure measured by the at least one pressure sensor lies within said tolerance pressure range, the pressure is not adapted. When the tolerance pressure range is exceeded or fallen short of, the control unit then activates the pump in order to pump up or to empty the pneumatic cushion.

Alternatively, the control unit can also be caused via an external signal to pump up or to empty the pneumatic cushion. For example, different flight phases can be identified or input via an external sensor system or input system, whereupon the control unit correspondingly pumps up or empties the pneumatic cushion.

Furthermore, in a further embodiment, the first pressure sensor can be connected to the second fluid line, wherein the control unit is configured in such a manner that the pneumatic cushion is inflated or emptied by activation of the pump depending on the pressure measured by the first sensor.

By connection of the first pressure sensor to the second feed line, the pressure prevailing outside the pneumatic cushion can be measured. The control unit is configured in particular in such a manner that the pneumatic cushion is emptied as the external pressure decreases and is inflated as the external pressure increases. As a result, an increase or a decrease of the seat hardness as a consequence of a changing external pressure can be compensated for.

When the pneumatic cushion according to the invention is used in an aircraft seat, the pressure measured in this embodiment by the first pressure sensor corresponds to the cabin pressure.

The first pressure sensor is preferably connected to the first fluid line, wherein a second pressure sensor is connected to the second fluid line in order to measure a prevailing pressure in the second fluid line, wherein the second pressure sensor is also connected to the control unit. The control unit is configured here in such a manner that it calculates a differential pressure between the pressure prevailing in the first fluid line and the second fluid line, wherein, when said differential pressure deviates from a desired differential pressure, the pump is activated in order to inflate or to empty the pneumatic cushion until the differential pressure corresponds to the predetermined desired differential pressure.

In this embodiment of the pneumatic cushion according to the invention, use is preferably made of a pump having two conveying directions.

The pressure prevailing in the volume of the pneumatic cushion can be measured with the first pressure sensor, and the pressure prevailing outside the pneumatic cushion or the pressure prevailing in a feedline can be measured with the second pressure sensor. Said pressure preferably corresponds to the ambient pressure which prevails around the pneumatic cushion. When the pneumatic cushion according to the invention is used in an aircraft seat, the pressure measured by the second pressure sensor corresponds to the cabin pressure.

The pump is preferably configured in such a manner that, in a switched-off state, it separates the first fluid line and the second fluid line from each other in a gas-tight manner.

As a result, when the pump is switched off, an escape of the fluid is prevented without an additional valve having to be used. As a result, firstly, weight can be saved and, secondly, the production costs of the pump unit can also be reduced.

As an alternative preference, a valve is arranged in the first fluid line and/or in the second fluid line, wherein the valve is connected to the control unit. An escape of fluid when the pump is switched off can be prevented by the valve.

Furthermore alternatively, a nonreturn valve can be provided in the first fluid line, preventing air from flowing out of the volume when the pump is in the switched off state. A nonreturn valve does not have to be actively switched, and therefore the design of the pneumatic cushion can be simplified.

The pump unit preferably has a connection with which the control unit can be connected to a bus system.

Firstly, the control unit and, with the latter, also the pump and the sensor/sensors can be supplied with power via the bus system. Secondly, it is also possible to control the connected pump units via the bus system, for example in order to change the desired pressure or the desired differential pressure. As a result, the pump unit can be used in a simple manner for a system with which individual regions of a seat can be individually adjusted in hardness by a passenger.

A further aspect of the present application relates to the use of a pneumatic cushion according to the invention in an aircraft seat.

A further aspect of the present application relates to a pump unit for a pneumatic cushion according to the invention, comprising a pump, a first fluid line and a second fluid line, wherein the pump, at least part of the first fluid line and the second fluid line are arranged in a common housing.

The present application furthermore relates to a method for automatically adapting the internal pressure of a pneumatic cushion depending on the pressure prevailing outside the pneumatic cushion, in particular using a pump unit which is arranged in a surface element of the pneumatic cushion. In a first step, the fluid pressure of the pneumatic cushion is measured. Particularly preferably, this measurement is performed by means of a pressure sensor which is connected to a first feedline of the pump unit according to the invention. In a second step, the measured fluid pressure is compared with a predetermined desired pressure, in particular by means of the control unit of the pump unit according to the invention. When the measured fluid pressure deviates from the predetermined desired pressure, a pump is activated in order to inflate or to empty the pneumatic cushion until the measured fluid pressure corresponds to the predetermined desired pressure.

In an alternative method, a pressure differential between the volume of the pneumatic cushion and the ambient pressure is determined. In the event of a deviation from a desired differential pressure or a desired differential pressure range, a pump and optionally a valve of a pump unit is or are switched in such a manner that the volume is filled with air or said volume is emptied.

Further advantageous embodiments and combinations of features of the invention emerge from the detailed description below and the entirety of the patent claims.

### BRIEF DESCRIPTION OF THE DRAWINGS

In the drawings used for explaining the exemplary embodiment:

FIG. 1 shows a schematic illustration of a pneumatic cushion according to the invention;

FIG. 2 shows a schematic cross section through a first embodiment of a pneumatic cushion according to the invention;

FIG. 3 shows a schematic cross section through a second embodiment of a pneumatic cushion according to the invention;

FIG. 4 shows a schematic cross section through a third embodiment of a pneumatic cushion according to the invention;

FIG. 5 shows a schematic cross section through a fourth embodiment of a pneumatic cushion according to the invention;

FIG. 6 shows a schematic cross section through a fifth embodiment of a pneumatic cushion according to the invention;

FIG. 7 shows a schematic cross section through a sixth embodiment of a pneumatic cushion according to the invention;

FIG. 8 shows a schematic cross section through a seventh embodiment of a pneumatic cushion according to the invention.

In principle, the same parts are provided with the same reference signs in the figures.

### WAYS OF IMPLEMENTING THE INVENTION

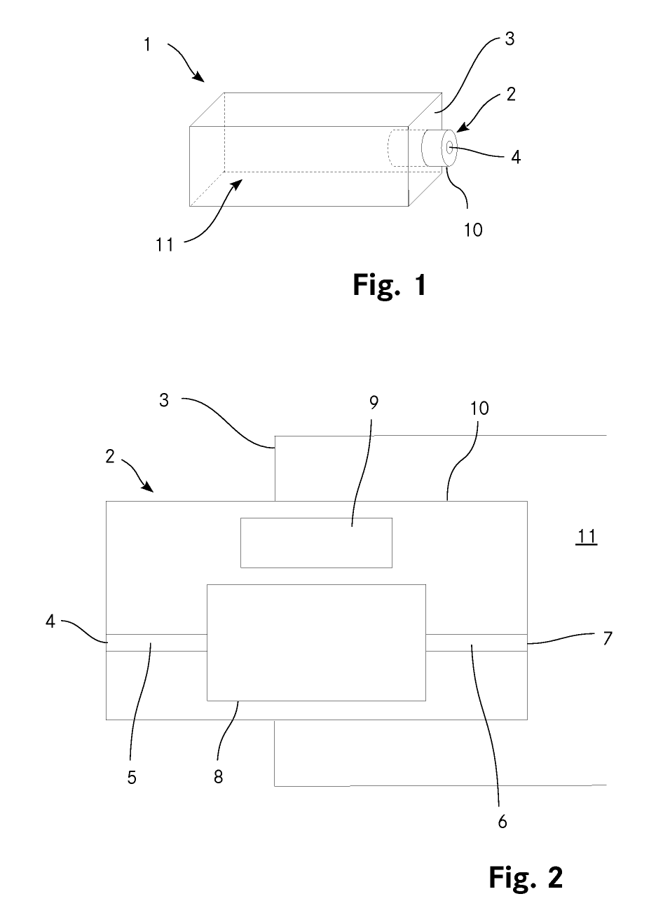

FIG. 1 shows a schematic perspective illustration of a pneumatic cushion 1 according to the invention with a pump unit 2. In the example shown, the pneumatic cushion 1 is cuboidal and accordingly has six surface elements which are connected to one another in a gas-tight manner. The surface elements define a volume 11 which is filled with air. The pump unit 2 is welded in an opening of a first surface element 3 of the pneumatic cushion 1. The pump unit 2 is arranged here in such a manner that a fluid inlet opening 4 is located on a housing 9 of the pump unit 2 outside the pneumatic cushion 1. The volume 11 of the pneumatic cushion 1 can be filled with air or emptied via the pump unit 2.

FIG. 2 shows a first embodiment of a pneumatic cushion 1 according to the invention in a sectional image, with the pump unit 2 being illustrated in detail. As can be seen, the pump unit 2 is arranged in a first surface element 3 of the pneumatic cushion 1. The fluid inlet opening 4 is located outside the pneumatic cushion 1. The fluid inlet opening 4 is adjoined by a second fluid line 5 which fluidically connects the fluid inlet opening 4 to a pump 8. On the side of the volume 11 of the pneumatic cushion 1, the pump 8 is fluidically connected to a first fluid line 6 which opens into an internal opening 7 which is arranged within the volume 11. Furthermore, a control unit 9 which activates or switches off the pump 8 in order to inflate or to empty the pneumatic cushion 1 is present in the housing 10 of the pump unit 2. In the exemplary embodiment shown in FIG. 2, the pump 8 is a pump having two directions of action, that is to say that the pump 8 can both charge the volume 11 with air and also suck the air out. Furthermore, in this exemplary embodiment, the pump 8 is configured in such a manner that, in the switched-off state, it separates the first fluid line 6 from the second fluid line 5 in a gas-tight manner.

In order to ensure functioning of the pump unit, the latter has a connection option to an external power supply, for example via a plug. Alternatively, however, the pump unit can also have an internal energy supply, for example via a battery or an accumulator. Furthermore, the pump unit 2 can also have a connection option for a bus system, as is shown in the embodiment according to FIG. 8. This is true of all of the embodiments which are disclosed in the present application.

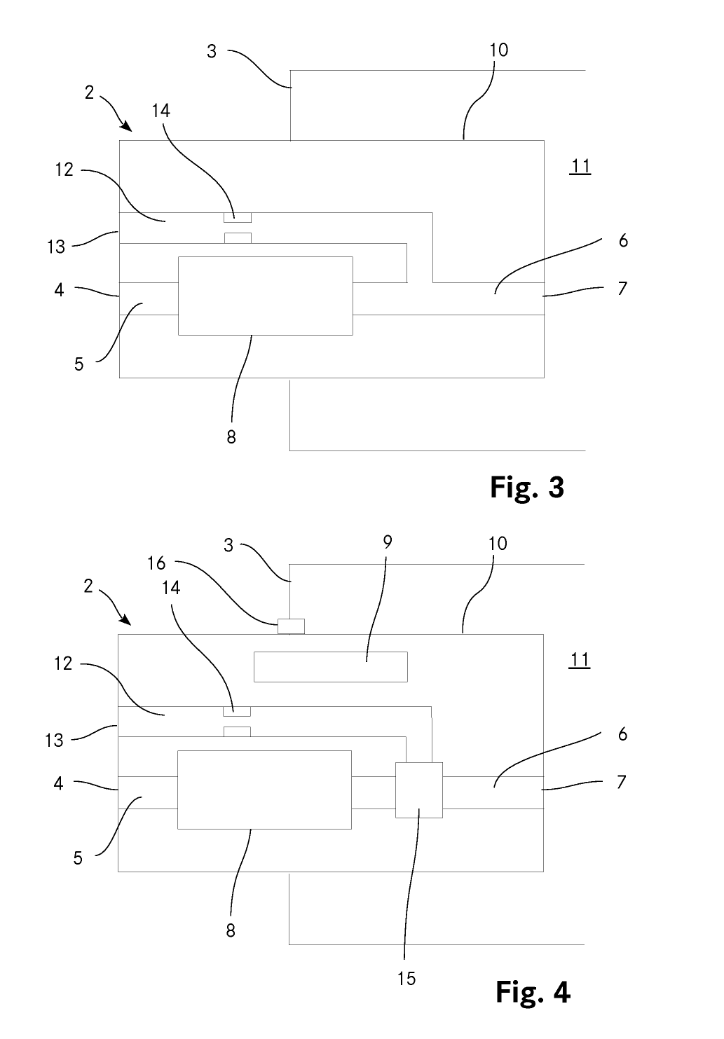

FIG. 3 shows a second embodiment of the present invention in side elevation. The pump unit 2 is again illustrated enlarged and in detail, while the volume 11 of the pneumatic cushion 1 is only shown in part.

In contrast to the embodiment according to FIG. 2, the pump unit 2 according to the present embodiment has a third fluid line 12 which is fluidically connected to the first fluid line 6. Furthermore, the pump unit 2 does not have a control unit 9.

The third fluid line 12 opens into a fluid outlet opening 13 which is arranged in the housing 10 outside the pneumatic cushion. A resistance 14, here illustrated schematically as a constriction of the cross section of the third fluid line 12, is arranged within the third fluid line 12. The quantity of air flowing through the third fluid line 12 can be limited to a maximum flow by means of the resistance 14.

The pump 8 continuously conveys air at a first pressure into the first fluid line 6. Some of the conveyed air will escape again via the third fluid line 12, while a further part of the conveyed air is conveyed via the internal opening 7 into the volume 11 of the pneumatic cushion 1. If the pressure in the volume 11 of the pneumatic cushion 11 exceeds the first pressure, air is pushed into the first fluid line 6 counter to the conveying direction of the pump 8, said air together with the air conveyed by the pump 8 escaping via the third fluid line 12. By means of a suitable selection of the conveying power of the pump 8 and of the maximum flow of the resistance 14, a defined pressure or pressure range can thus be maintained within the volume 11. The resistance 14 can also be configured here as a pressure control valve which opens only when a certain pressure is exceeded.

FIG. 4 shows a third embodiment of the pneumatic cushion according to the invention, again in a schematic sectional image with a more detailed view of the pump unit 2.

In this embodiment, the pump unit 2 has a pressure differential sensor 16 which measures the pressure differential between the pressure prevailing in the volume 11 and the pressure prevailing in the surroundings. Furthermore, a valve 15 is arranged in the first fluid line 6. In the embodiment shown, the valve 15 is configured as a 3/2-way valve, wherein the third fluid line 12 is connected to the first fluid line 6 via the valve 15. The control unit 9 switches the valve 15 and the pump 8 on the basis of the pressure differential, which is measured by the pressure differential sensor 16, between the volume 11 and the surrounding atmosphere.

In the normal state, that is to say when the differential pressure measured by the pressure differential sensor 16 corresponds to a predetermined desired differential pressure or lies within a desired differential pressure range, the valve 15 is switched in such a manner that the pump 9 is fluidically connected to the volume 11 of the pneumatic cushion 11. The pump 9 according to the exemplary embodiment shown is a pump which, in the switched-off state, separates the first fluid line 6 from the second fluid line 5 in a gas-tight manner. In particular, in the exemplary embodiment shown, the pump 9 is a diaphragm pump.

If the pressure differential measured by the pressure differential sensor 16 lies above a desired differential pressure or above a desired differential pressure range, the control unit 9 switches the valve 15 in such a manner that the volume is fluidically connected to the third fluid line 12. As a result, air can flow out of the volume 11 via the third fluid line and the fluid outlet opening 13 in order to empty the pneumatic cushion 1. If the pressure differential measured by the pressure differential sensor 16 corresponds to the desired differential pressure or if said pressure differential lies within the desired differential pressure range, the control unit 9 switches the valve 15 in such a manner that the volume 11 is fluidically connected to the pump 8. Since the pump 8 separates the first fluid line 6 from the second fluid line 5 in a gas-tight manner, air can no longer flow out of the volume 11.

If, by contrast, the measured pressure differential falls short of the desired differential pressure or if said pressure differential lies below the desired differential pressure range, the control unit 9 activates the pump 8 so that air can be conveyed by the latter via the fluid inlet opening 4 and the second fluid line 5 into the first fluid line 6 and via the internal opening 7 into the volume 11. If the pressure differential measured by the pressure differential sensor 16 corresponds to the desired differential pressure or if said pressure differential lies within the desired differential pressure range, the control unit 9 switches off the pump 8 again.

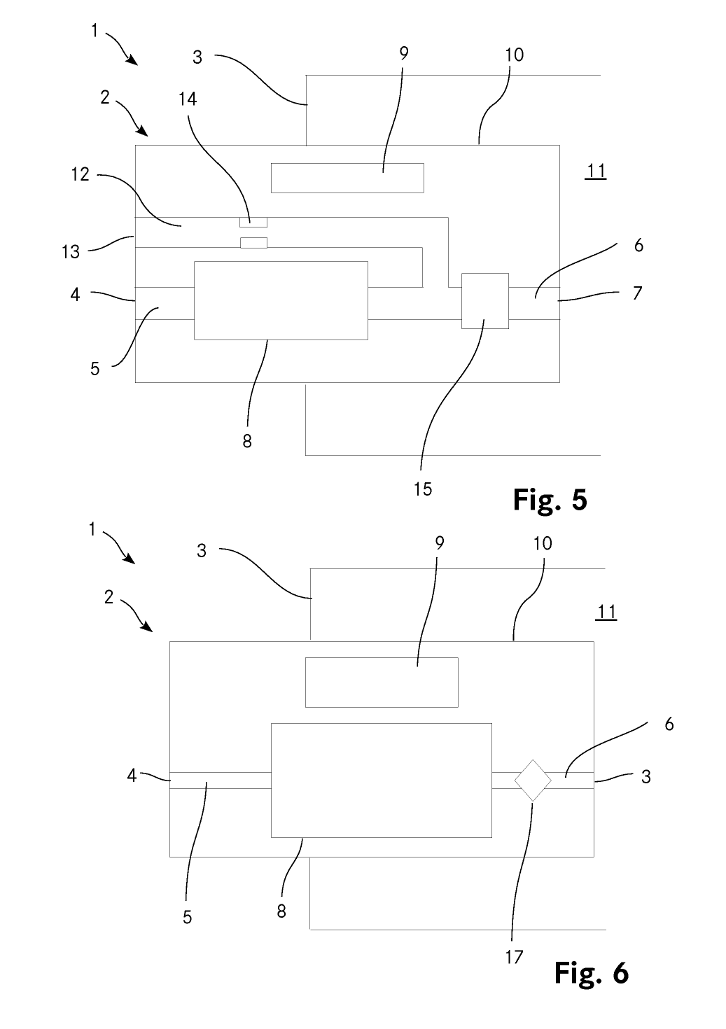

FIG. 5 shows a fourth embodiment of the present invention, again in a schematic sectional image with a more detailed view of the pump unit 2. In this embodiment, the third fluid line 12 is connected in the pump unit 2 to the first fluid line 6 in a region located between the valve 15 and the pump 8. In the embodiment shown, the valve 15 is configured as a 2/2-way valve.

If the pressure differential measured by the pressure differential sensor 16 lies above a desired differential pressure or above a desired differential pressure range, the control unit 9 opens the valve 15. As a result, air can flow out of the volume 11 via the third fluid line and the fluid outlet opening 13 in order to empty the pneumatic cushion 1. If the pressure differential measured by the pressure differential sensor 16 corresponds to the desired differential pressure or if said pressure differential lies within the desired differential pressure range, the control unit 9 blocks the valve 15.

If, by contrast, the measured pressure differential falls short of the desired differential pressure or said pressure differential lies below the desired differential pressure range, the control unit 9 activates the pump 8 and opens the valve 15. As a result, air is conveyed into the volume 11 and into the surroundings again via the third fluid line 12. The conveying volume of the pump 8 is selected here in such a manner that it is higher than the maximum flow, which is defined by the resistance 14, through the third fluid line 12, and therefore the volume 11 of the pneumatic cushion 11 can be filled despite air flowing off via the third fluid line 12.

If the pressure differential measured by the pressure differential sensor 16 corresponds to the desired differential pressure or said pressure differential lies within the desired differential pressure range, the control unit 9 switches off the pump 8 again and closes the valve 15.

FIG. 6 shows a schematic cross section of a fifth embodiment of the pneumatic cushion 1 according to the invention. The pump 8 of the pump unit 2 is configured as a pump having two conveying directions. In the embodiment shown, a first pressure sensor 17 is connected to the first fluid line 6. The control unit 9 has a printed circuit board and preferably a microchip with which pressure measurements of the first pressure sensor can be evaluated in order to activate the pump 8 depending on the pressure measurements. The control unit 9 is configured in such a manner that the pump 8 is activated depending on the pressure measured by the first pressure sensor 17, in order to convey air into the volume 11 of the pneumatic cushion 1 or to actively empty said volume. The pump 8 is designed in such a manner that, in the switched-off state, it separates the first fluid line 6 and the second fluid line 5 from each other in a gas-tight manner in order to prevent air from escaping from the pneumatic cushion 1.

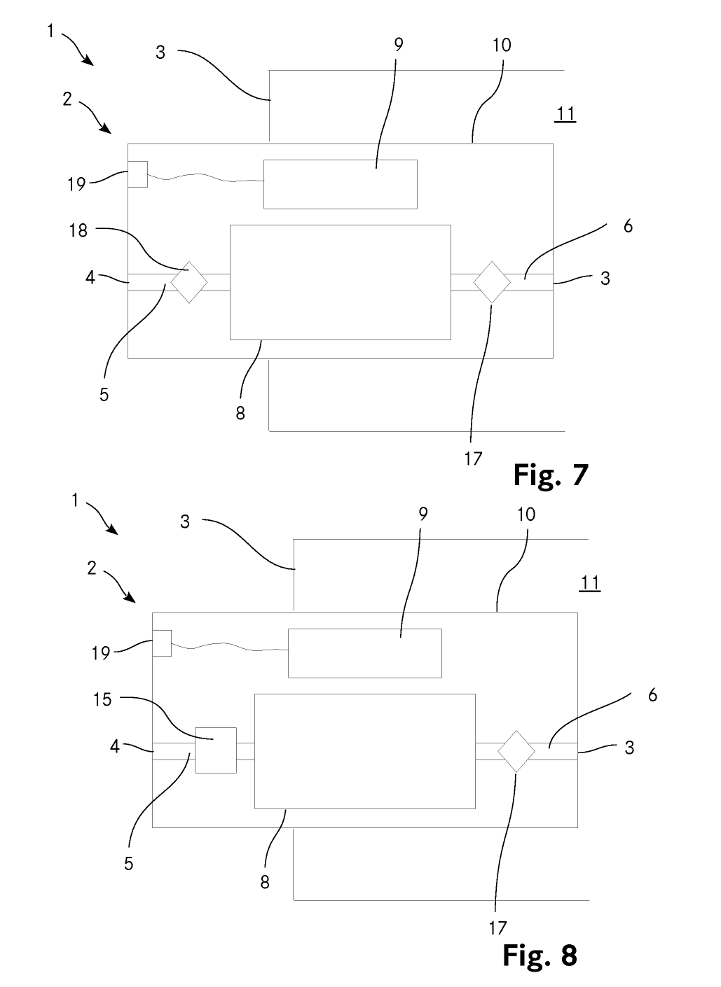

FIG. 7 shows a further embodiment of the pneumatic cushion 1 according to the invention. In contrast to the embodiment according to FIG. 6, the pump unit 2 has a second pressure sensor 18 which is connected to the second fluid line 5. As a result, in addition to the pressure prevailing in the first fluid line 6, and in the volume 11, the pressure prevailing in the second fluid line 5 can additionally be measured. This pressure generally corresponds to the ambient pressure. Furthermore, the embodiment, shown in FIG. 7, of the pump unit 2 has a connection 19 in order to connect the pump unit 2 to a bus system (not shown). The control unit 9 can be activated via the bus system, for example in order to change a desired pressure value.

FIG. 8 illustrates a further embodiment of the pneumatic cushion 1 according to the invention. This embodiment substantially corresponds to the embodiment of FIG. 7, with a valve 15 additionally being arranged in the second fluid line 5. The valve 15 can prevent air from escaping from the volume 11 of the pneumatic cushion 1, in particular if the pump 8 does not permit a gas-tight separation between the first fluid line 6 and the second fluid line 5.

1. A pneumatic cushion, in particular for an aircraft seat, comprising at least two surface elements which are connected to one another all around at their edges in a gas-tight manner such that a volume which is fillable with air is produced between the at least two surface elements, wherein the pneumatic cushion has a pump unit which comprises a pump, a first fluid line which connects the pump to the volume of the pneumatic cushion, and a second fluid line with which the pump is connected to a fluid inlet opening, wherein the pump, at least part of the first fluid line and the second fluid line are arranged in a common housing.

2. The pneumatic cushion as claimed in claim 1, wherein the housing penetrates one of the at least two surface elements.

3. The pneumatic cushion as claimed in claim 1, wherein the pump unit has a third fluid line with which the volume of the pneumatic cushion is connectable to a fluid outlet opening.

4. The pneumatic cushion as claimed in claim 3, wherein the third fluid line has a resistance, in particular a narrowed point or a throttle valve.

5. The pneumatic cushion as claimed in claim 3, wherein the third fluid line is connected to the first fluid line.

6. The pneumatic cushion as claimed in claim 3, wherein the pump unit has a first pressure differential sensor with which a pressure differential between the volume of the pneumatic cushion and the ambient pressure can be measured, and a control unit, wherein the control unit is configured in such a manner that, when a pressure differential measured by the first pressure differential sensor falls short of a predetermined desired differential pressure, the pump is activated in order to inflate the pneumatic cushion until the measured pressure differential corresponds to the predetermined desired differential pressure.

7. The pneumatic cushion as claimed in claim 6, wherein the first fluid line has a valve.

8. The pneumatic cushion as claimed in claim 7, wherein the valve is a 3/2-way valve, and wherein the third fluid line is connected to the first fluid line via the valve, and the control unit is furthermore configured in such a manner that, when the predetermined desired differential pressure is exceeded, the valve is switched in such a manner that the volume of the pneumatic cushion is connected to the fluid outlet opening via the third fluid line until the measured pressure differential corresponds to the desired differential pressure.

9. The pneumatic cushion as claimed in claim 7, wherein the third fluid line between the pump and the valve is connected to the first fluid line.

10. The pneumatic cushion as claimed in claim 9, wherein the control unit is configured in such a manner that, when the desired differential pressure is exceeded or fallen short of, the valve is opened.

11. The pneumatic cushion as claimed in claim 1, wherein a first pressure sensor is connected to the first fluid line in order to measure a pressure prevailing in the first fluid line, and the control unit is configured in such a manner that, by activation of the pump, the pneumatic cushion is inflated or emptied depending on the pressure measured by the first sensor.

12. The pneumatic cushion as claimed in claim 11, wherein a second pressure sensor is connected to the second fluid line in order to measure a pressure prevailing in the second fluid line, and wherein the control unit is configured in such a manner that the latter calculates a differential pressure between the pressure prevailing in the first fluid line and the pressure prevailing in the second fluid line and, when the differential pressure deviates from a predetermined desired differential pressure, activates the pump in order to inflate or to empty the pneumatic cushion until the differential pressure corresponds to the predetermined desired differential pressure.

13. The pneumatic cushion as claimed in claim 1, wherein the pump is configured in such a manner that, in a switched-off state, it separates the first fluid line and the second fluid line from each other in a gas-tight manner.

14. The pneumatic cushion as claimed in claim 11, wherein a valve is arranged in the first fluid line and/or in the second fluid line.

15. The pneumatic cushion as claimed in claim 1, wherein the pump unit has a connection with which the control unit can be connected to a bus system.

16. The use of a pneumatic cushion as claimed in claim 1 in an aircraft seat.

17. A pump unit for a pneumatic cushion as claimed in claim 1, comprising a pump, a first fluid line with which the pump is connectable to the volume of the pneumatic cushion, and a second fluid line with which the pump is connected to a fluid inlet opening, wherein the pump, at least part of the first fluid line and the second fluid line are arranged in a common housing.

18. The pneumatic cushion as claimed in claim 4, wherein the resistance is a narrowed point or a throttle valve.
